(19) United States
(12) Patent Application Publication
(10) Pub. No.: US 2018/0179813 A1
(43) Pub. Date: Jun. 28, 2018

(54) Dual Layered Balcony Cover

(71) Applicant: Alexander Sperber, Fort Lauderdale, FL (US)

(72) Inventor: Alexander Sperber, Fort Lauderdale, FL (US)

(21) Appl. No.: 15/391,817

(22) Filed: Dec. 27, 2016

(51) Int. Cl. E06B 9/44; E06B 9/68; E06B 9/52; E06B 9/50

(52) U.S. Cl. CPC E06B 9/44; E06B 9/68; E06B 2009/2452; E06B 9/50; E06B 9/521

(57) ABSTRACT

A dual layered balcony cover. The invention protects a balcony from heavy wind, heavy rain, mosquitos/insects, birds, and provides solar shading. The invention contains a plurality of pairs of roller tubes which allow a layer of insect screen to be released (inner layer of invention) and a layer of vinyl to be released (outer layer of invention) either individually or concurrently utilizing a control system with a remote control included with the invention. There are zippers positioned between the roller tubes which zip and unzip the segments of insect screen and segments of vinyl automatically when the invention ascends and descends. The invention contains protective casing that houses both sets of multiple roller tubes with slits. The top of the casing itself contains a slant shaped design which allows rain to drop away from the balcony. Right over that, there is a sensor which will be programmed to activate the control system affecting the inner layer and outer layer of the invention due to environmental circumstances which makes the invention a fully automated product.

### BACKGROUND OF THE INVENTION

### 1. Field of the Invention

This invention relates to the field of amenity type products for the luxury real estate, luxury hotel market, and cruise ship market. More specifically, the invention comprises a dual layered balcony cover that effectively protects an apartment, condominium, hotel, and cruise ship balcony from heavy wind, heavy rain, mosquitos/insects/bees, bird infiltration as well as provides solar shading.

### 2. Description of the Related Art

On the current market, there are balcony covering shade type covers that protect a balcony of the sun, dust, and birds. This product contains a pulley like system that rolls up the balcony shade type cover in approximately 15 seconds. Multiple units would need to be installed given a large balcony with many open sides.

In addition, there are motorized retractable screens for patios, porches, as well as other large openings that contains a roller with insect screen type material that offers customer's insect protection, solar shading, and privacy. This motorized retractable screen contains a weighted side-bar towards the bottom of the product. This product contains a control system that activates the product with either a remote control or a wall switch.

### BRIEF SUMMARY OF THE PRESENT INVENTION

The present invention consists of two sets of multiple roller tubes that contain vinyl material and an insect screen. These two sets are encased in protective housing which contains a right angle trapezoid shaped design. The top of the protective housing has a slant which allows rain to fall away from the balcony. There is one control system that rolls out the vinyl material and insect screen individually as well as together with the push of remote control buttons. Two remote controls will be included with the invention. One will be portable and one will be attached to a holder that is located on one of the customer's walls. Both will include two buttons that allow the customer to activate each set of multiple roller tubes. Roller tubes containing the vinyl and insect screen will contain a zipper like mechanism that is positioned between the roller tubes that automatically zips the segments of vinyl together as well as the segments of insect screen together as the roller tubes of the invention descend. The zipper like mechanism will also unzip as the roller tubes containing the vinyl and insect screen ascend. A rectangular shaped balcony with three open sides will contain three roller tubes on the inner part of the balcony containing the insect screen and three roller tubes on the outer of the balcony containing the vinyl material. This comprises the inner layer of the invention and the outer layer of the invention. In this example, for each set of roller tubes, there will be two roller tubes that are parallel to each other on the left and right sides of the balcony comprising the width of the balcony that are perpendicular to the roller tubes that comprises the length of the balcony.

Both layers of roller tubes will be encased in a right angle trapezoid shaped protective housing unit. There will be one motor per layer that ascends and descends each layer and a set of ball bearings per roller tube. There are counterweight bars located at the bottom of both layers that weigh the layers down so that they do not flop in the wind. Both layers of the invention will drop down so that the counterweight bar extends right past the guard rail for glass enclosed balconies. For individual metal railed balconies, the counterweight bar extends and lays flat on the ground. With both of these similar but alternate designs, the inner layer of the invention containing the insect screen will effectively protect a balcony from birds, mosquitos, and insects as well as provide solar shading. The outer layer of the invention containing the vinyl will effectively protect a balcony from heavy wind and heavy rain.

There will be a 3 in 1 rain, wind, and sun sensor that will be attached to the side on of the protective housing unit. The sensor will descend the outer layer of vinyl when a certain amount of rain touches the sensor. In the situation where a large storm was to occur, all of the customer's balcony furniture will get wet from that storm if there is heavy wind. Cushioned balcony furniture in particular will stay drenched and dirty for one or more days. With this invention, the rain sensor provides a safety net system that eliminates the possibility of that happening. The wind portion of the sensor automatically brings down the vinyl when a certain amount of wind affects the sensor. The sun portion of the sensor will automatically bring down the insect screen providing solar shading for the user. Not only will this invention automatically bring down the layers, it will automatically be able to bring up the layers at the right times due to a custom controller with custom programming.

The protective housing unit will contain slits that allow either layer individually or both concurrently to descend freely through the slits due to the motor and ball bearing system. There will be magnets and magnetic strips for the inner and outer layer that allow the magnets to attach to the magnetic strips so that a seal is created for each layer. This will provide secure protection against the rain, wind, and mosquitos/birds/insects.

### BRIEF DESCRIPTION OF THE SEVERAL VIEWS OF THE DRAWINGS

“The patent or application file contains at least one drawing executed in color. Copies of this patent or patent application publication with color drawing(s) will be provided by the Office upon request and payment of the necessary fee.”

FIG. 1 is a perspective view, showing the invention and focusing on the slant aspect of the protective housing.

FIG. 2 is a perspective view, showing the sensor.

FIG. 3 is a perspective view, showing zipper mechanism situated in inner layer.

FIG. 4 is a perspective view, showing the slits where the inner layer of invention and outer layer of invention descend and ascend.

FIG. 5 is a perspective view, showing invention with solid glass enclosed balconies when both layers are ascended.

FIG. 6 is a perspective view, showing both layers of invention fully ascended into protected housing for balconies with individual metal rails.

FIG. 7 is a perspective view, showing zipping mechanism from a perspective outside of balcony for the outer layer.

FIG. 8 is a perspective view, showing a balcony with a solid glass enclosure compared to a balcony with individual railing from the perspective of being outside looking in while both layers are completely descended.

FIG. 9 is a perspective view, showing a balcony with a solid glass enclosure compared to a balcony with individual railing with the perspective of being inside looking out while both layers are completely descended.

### REFERENCE NUMERALS IN THE DRAWINGS

10 3 in 1 rain, wind, and sun sensor

12 zipper mechanism

14 protective housing

16 solid glass enclosure

18 individual metal bars

20 outer layer

22 inner layer

24 slit

### DETAILED DESCRIPTION OF THE INVENTION

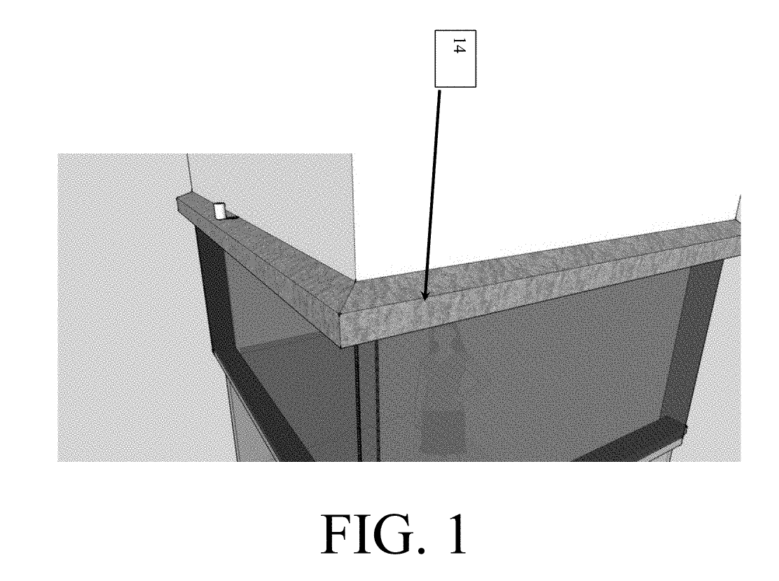

FIG. 1 shows a perspective view of the present invention focusing on the slant design that that the protective housing unit has. This will allow rain to fall off the balcony without intruding the balcony.

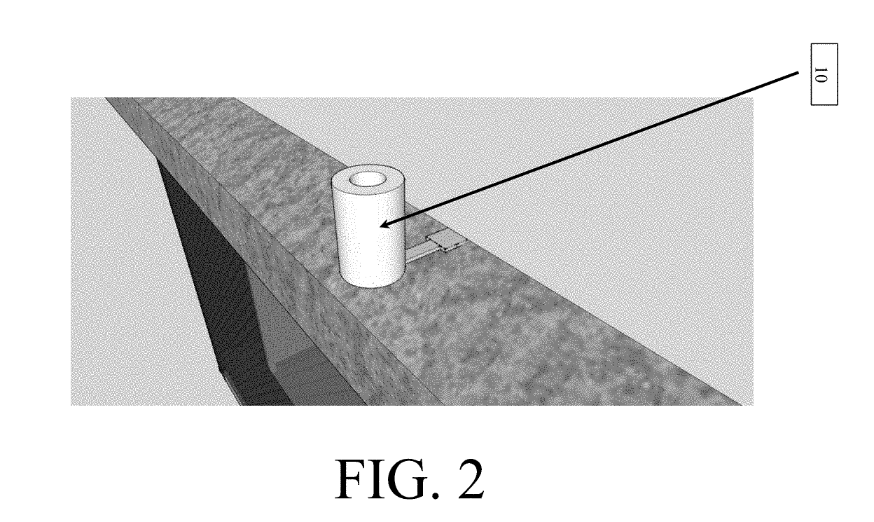

FIG. 2 shows a perspective close up view of the sensor. It sits right on top of the protective housing. It will be programmed to activate the outer layer (vinyl layer) of invention.

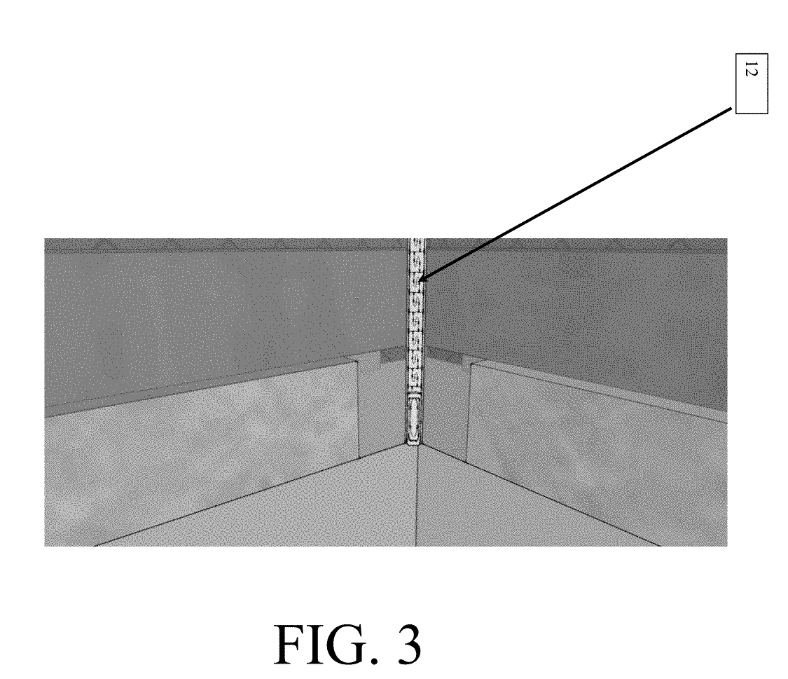

FIG. 3 shows a close up of the zipper mechanism. This zipper will unzip and zip automatically as control system activates the inner and or outer layer.

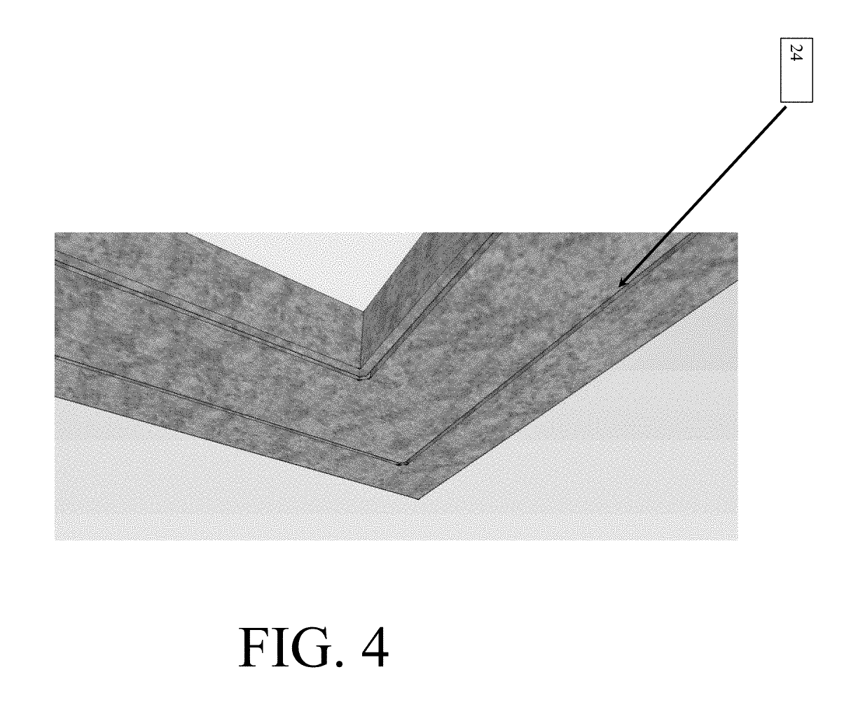

FIG. 4 shows the slits in which inner layer and outer layer of invention descend and ascend. It's specially designed so that both layers of the invention can freely ascend and descend.

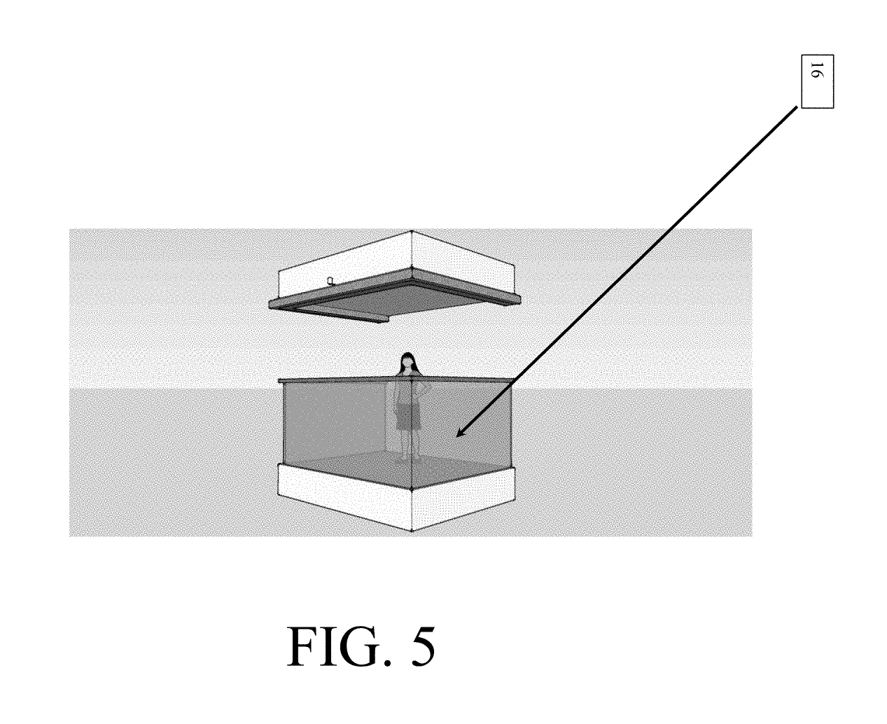

FIG. 5 shows both inner layer and outer layer of invention fully ascended. As can be seen, the design allows the user to fully enjoy his/her balcony without having to worry about something obstructing his/her view.

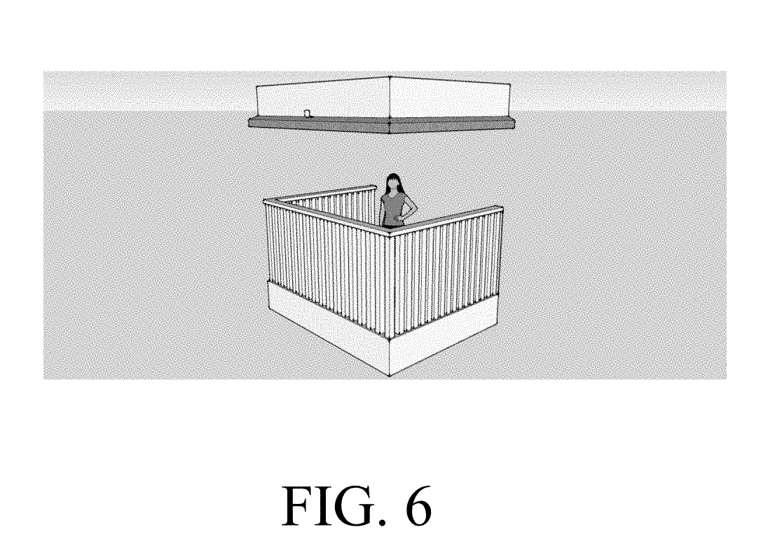

FIG. 6 shows both layers of the invention ascended for balconies with individual metal railing systems. It shows that the customer's view is not obstructed when the balcony is not covered.

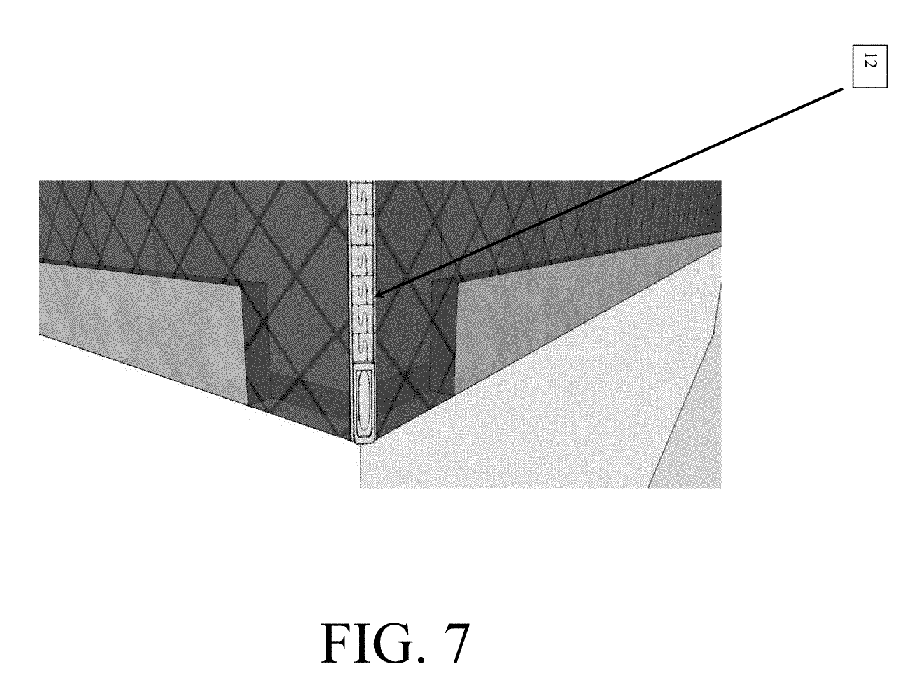

FIG. 7 shows the perspective view of the zipper from an outside perspective that shows the zipper positioned within outer layer.

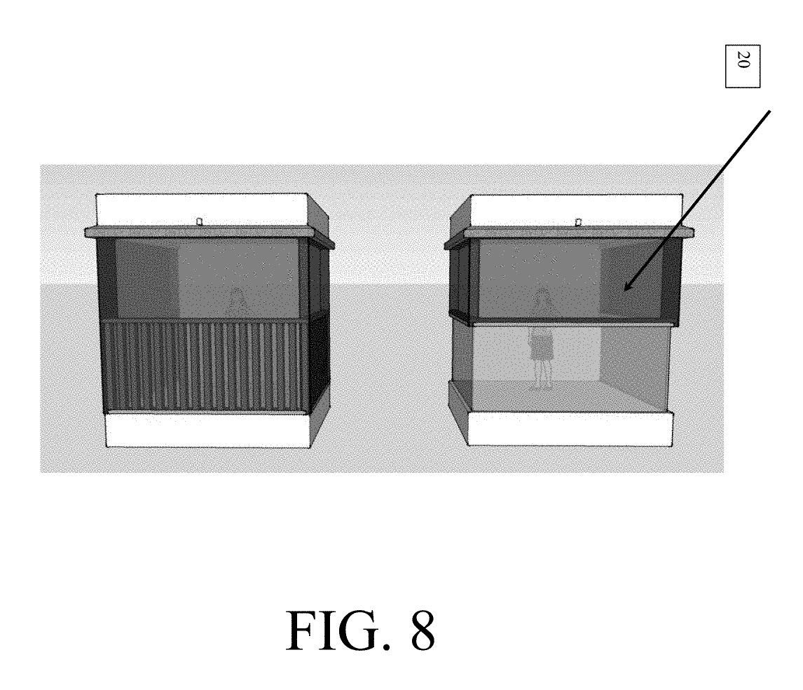

FIG. 8 shows perspective view of both solid glass enclosed balconies and individual metal railed balconies side by side as if looking at balcony from an outside perspective.

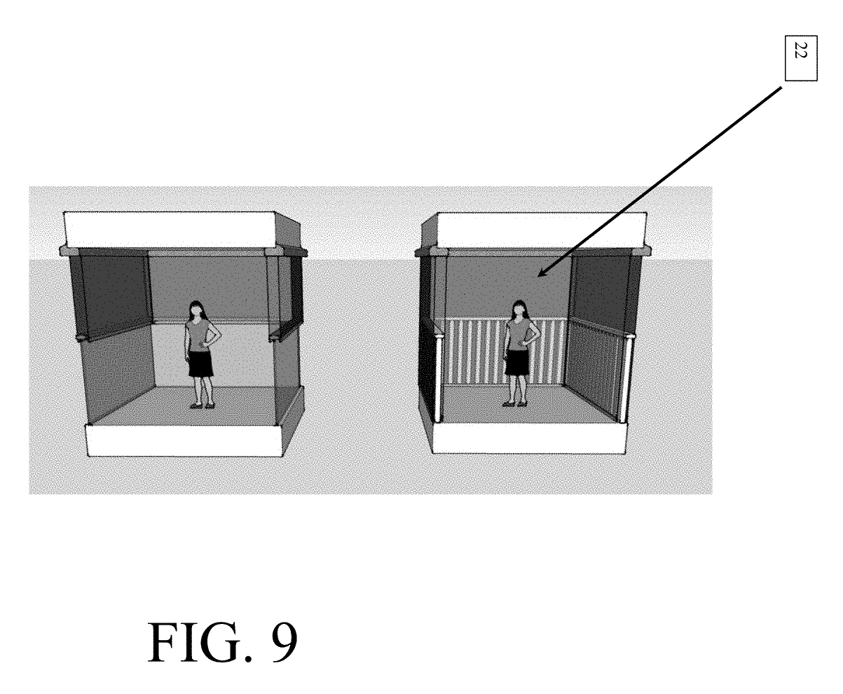

FIG. 9 shows perspective view of both solid glass enclosed balconies and individual metal railed balconies side by side as if looking at balcony from inside a room looking out towards balcony.

Having described my invention, I claim:

1. A dual layered balcony cover for a balcony having a floor, at least one railing, an inside and an outside, the cover comprising:
(a) an inner layer of the invention comprising a plurality of roller tubes containing a insect screen having an interior, an exterior, a top, a bottom and a length;
(b) an outer layer of the invention comprising a plurality of roller tubes comprising a vinyl material having an interior, an exterior, a top, a bottom and a length;
(c) zipper like mechanism that is positioned between two of the plurality of roller tubes for both the inner layer and the outer layer;
(d) a 3 in 1 rain, wind, and sun sensor that is placed directly on top of a protective housing unit;
(e) motors contained within the inner layer and outer layer;
(f) magnets attached to the interior of the outer layer;
(g) magnets attached to the exterior of the inner layer;
(h) magnetic strip attachments located on the railing;
(i) counterweight bars attached to the bottom of the plurality of vinyl and insect screen roller tubes of the inner and outer layers;
(j) sets of ball bearings within the roller tubes associated with the inner and outer layers;
(k) the protective housing unit is right angle trapezoid shaped and has a top;
(l) a set of two remotes with two buttons each;

2. A dual layered balcony cover as recited in claim 1, wherein the inner layer protects an apartment, hotel, condominium, or cruise ship balconies from insects, birds, bees, mosquitos, and also provides solar shading.

3. A dual layered balcony cover as recited in claim 1, wherein the outer layer protects an apartment, hotel, condominium, or cruise ship balconies from heavy wind and heavy rain.

4. A dual layered balcony cover as recited in claim 1 wherein a control system activates the motors either separately or concurrently.

5. A dual layered balcony cover as recited in claim 4, the ball bearings within each individual roller tube allow the inner and outer layers to ascend and descend once the control system activates the motors.

6. A dual layered balcony cover as recited in claim 4, wherein the two remotes activate the control system.

7. A dual layered balcony cover as recited in claim 1, wherein the 3 in 1 rain, wind, and sun sensor automatically descends the outer layer of vinyl if rain touches the sensor.

8. A dual layered balcony cover as recited in claim 1, wherein the 3 in 1 rain, wind, and sun sensor automatically descends the outer layer of vinyl if wind affects the sensor.

9. A dual layered balcony cover as recited in claim 1, wherein the 3 in 1 rain, wind, and sun sensor automatically descends the inner layer of insect screen if enough sunlight/heat affects the sensor.

10. A dual layered balcony cover as recited in claim 1, wherein a custom controller with custom programming automatically ascends the outer layer of vinyl if there is no wind or rain present.

11. A dual layered balcony cover as recited in claim 1, wherein a custom controller with custom programming automatically ascends the inner layer of insect screen if sunlight dies down.

12. A dual layered balcony cover as recited in claim 1, wherein the zipper like mechanism is positioned between two of the plurality of roller tubes within both the inner layer and the outer layer, and zips the outer layer of vinyl together as well as zips the inner layer of insect screen together for one layer individually or both layers concurrently as it descends.

13. A dual layered balcony cover as recited in claim 1, wherein the zipper like mechanism is positioned between two of the plurality of roller tubes within both the inner layer and the outer layer, and unzips the outer layer of vinyl as well as unzips the inner layer of insect screen for one layer individually or both layers concurrently as it ascends.

14. A dual layered balcony cover as recited in claim 1, wherein the counterweight bars weigh both outer layer and inner layer of invention so that the layers are relatively stable when heavy wind and or heavy rain is present.

15. A dual layered balcony cover as recited in claim 1, further comprising alternate lengths of the inner layer and the outer layer depending on whether the balcony is enclosed by solid glass or by individual railings.

16. A dual layered balcony cover as recited in claim 11, wherein the inner layer and the outer layer descend to touch the floor if balcony contains individual railings.

17. A dual layered balcony cover as recited in claim 11, wherein the inner layer and the outer layer extend just below the at least one balcony railing if the balcony contains enclosed solid glass.

18. A dual layered balcony cover as recited in claim 1, wherein right angle trapezoid shaped protective housing contains both the inner layer and the outer layer.

19. A dual layered balcony cover as recited in claim 14, the protective housing further comprising two slits that allow the inner layer and the outer layer to descend or ascend.

20. A dual layered balcony cover as recited in claim 14, the protective housing further comprising a slant type design at the top which allows rain to fall away from balcony.
